(19) United States
(12) Patent Application Publication
(10) Pub. No.: US 2016/0132230 A1
(43) Pub. Date: May 12, 2016

(54) TOUCH SCREEN OPERATING METHOD AND ELECTRONIC DEVICE

(71) Applicant: ASUSTeK COMPUTER INC., Taipei City (TW)

(72) Inventor: Shu-Hui Chou, Taipei City (TW)

(21) Appl. No.: 14/932,936

(22) Filed: Nov. 4, 2015

(30) Foreign Application Priority Data
Nov. 7, 2014 (TW) 103138731

(51) Int. Cl. G06F 3/0488; G06F 3/0485; G06F 3/0482; G06F 3/0484; G06F 3/041; G06F 3/0483

(52) U.S. Cl. CPC G06F 3/04883; G06F 3/0412; G06F 3/0483; G06F 3/0482; G06F 3/04842; G06F 3/0485; G06F 3/04847; G06F 2203/04803; G06F 2203/04104; G06F 2203/04808

(57) ABSTRACT

A touch screen operating method and an electronic device are provided. In the method, a touch operation gesture at a touch screen is detected, and the touch screen displays at least a portion of a plurality of data items in a data page. The data items are slid according to the touch operation gesture. When the data items are slid to an edge of the data page, they are stacked.

### CROSS-REFERENCE TO RELATED APPLICATION

This application claims the priority benefit of Taiwan application serial No. 103138731, filed on Nov. 7, 2014. The entirety of the above-mentioned patent application is hereby incorporated by reference herein and made a part of specification.

### BACKGROUND OF THE INVENTION

1. Field of the Invention

The invention relates to a touch operating method and a device and, more particularly, to a touch screen operating method and an electronic device.

2. Description of the Related Art

Conventionally, in order to display more data items in a limited space of a screen, the data items of a portable device, such as a smart phone, are displayed on the screen in a list for the user to browse and check. When the data items of the data page are beyond the displaying area of the screen, the portable device only displays a part of the data items on the screen, and the user can slide on the screen to scroll the data page to search the target data rapidly.

In the scrolling of the data page, the scrolling usually stops instantly when the data page reaches an edge. At the moment, even though the user keeps the sliding operation, the data page would not be scrolled. Thus, the user may be puzzled due to no feedback. Consequently, the operating systems of many mobile devices provide various mechanisms to remind the user that the data page is already scrolled to an edge. For example, in the Android system, a translucency glow effect appears at the edge to reminder users when the data page scrolls to the edge; in the iOS system, a rubber-banding effect appears to remind that the data page is already scrolled to the edge.

### BRIEF SUMMARY OF THE INVENTION

A touch screen operating method applied to an electronic device with a touch screen is provided. In the method, a touch operation gesture at the touch screen is detected, and the touch screen displays at least a portion of a plurality of data items in a data page. Then, the data items are slid according to the touch operation gesture. When the data items are slid to an edge of the data page, the data items are stacked.

An electronic device is further provided, and it includes a touch screen, a storage unit and a processing unit. The storage unit includes multiple modules. The processing unit is coupled to the touch screen and the storage unit to access and execute the modules stored in the storage unit. The modules include a display module, a detecting module, a sliding module and a stacking module. The display module displays at least a portion of a plurality of data items of a data page at the touch screen. The detecting module detects a touch operation gesture on the displayed data items via the touch screen. The sliding module slides the data items according to the touch operation gesture. The stacking module stacks the data items when the sliding module determines the data items are slid to an edge of the data page.

These and other features, aspects and advantages of the present invention will become better understood with regard to the following description, appended claims, and accompanying drawings.

### BRIEF DESCRIPTION OF THE DRAWINGS

FIG. 1 is a block diagram showing an electronic device in an embodiment;

FIG. 2 is a flow chart showing a touch screen operating method in an embodiment;

FIG. 3 is a schematic diagram showing a data page in an embodiment;

FIG. 4 is a schematic diagram showing a touch screen operating method in an embodiment;

FIG. 5 is a schematic diagram showing a touch screen operating method in an embodiment;

FIG. 6 is a schematic diagram showing a touch screen operating method in an embodiment; and

FIG. 7 is a schematic diagram showing a touch screen operating method in an embodiment.

### DETAILED DESCRIPTION OF THE EMBODIMENTS

In a touch screen operating method applied to an electronic device, when the user slides the data items of the data page to the edge, the data items of the data page are stacked according to a touch operation gesture, so as to remind the user that the data page is already slid to the edge. In an embodiment, the staked direction of the data items of the data page and a sliding direction of the touch operation gesture are the same. In an embodiment, the staked direction of the data items of the data page is opposite to the sliding direction of the touch operation gesture. In an embodiment, the data items of the data page are stacked according to a sliding distance and a sliding speed of a finger of the touch operation gesture. The previous data item overlaps a part of the next data item, and the overlap ratio is determined by the sliding distance or the sliding speed of the touch operation gesture, which is not limited herein. Thus, the user not only knows that the data page is slid to the edge, but also can check the contents of the data items from the non-overlapping part, which provides a better using experience.

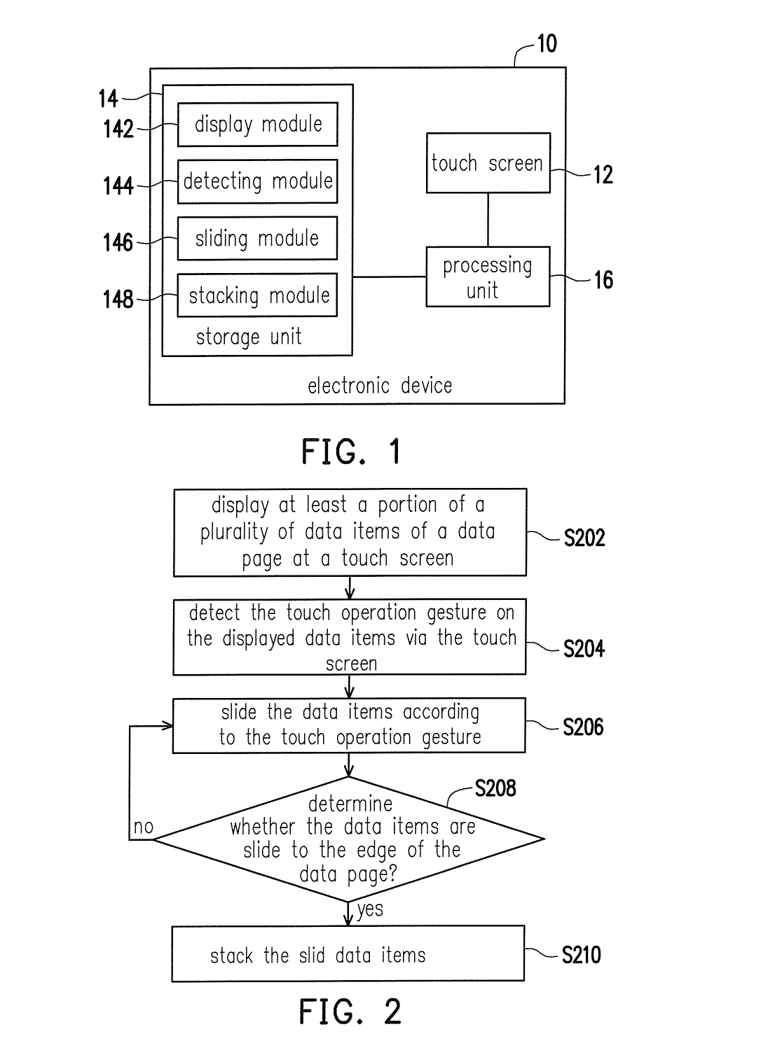

FIG. 1 is a block diagram showing an electronic device in an embodiment. Please refer to FIG. 1, the electronic device 10 in the embodiment includes a touch screen 12, a storage unit 14 and a processing unit 16. The electronic device 10 may be a mobile phone, a tablet computer, a media player, a navigation device or a vehicle computer, and the touch screen 12 as an inputting module of the electronic device 10, which is not limited herein.

The touch screen 12 may integrate a resistive, capacitive or optical touch detecting element and a liquid crystal display (LCD), and the touch screen 12 can display images of the electronic device 10 and detect a touch operation gesture at the same time.

The storage unit 14 may be one or a combination of a fixed or portable random access memory (RAM), a read-only memory (ROM) and a flash memory in any types. In the embodiment, the storage unit 14 stores a display module 142, a detecting module 144, a sliding module 146 and a stacking module 148. The modules may be programs stored in the storage unit 14, and they can be loaded by the processing unit 16 of the electronic device 10 to achieve the functions of the touch screen.

The processing unit 16 is coupled to the touch screen 12 and the storage unit 14, respectively. the processing unit 16 may be one or a combination of a central processing unit (CPU), a programmable microprocessor for common use or specific use, a digital signal processor (DSP), a programmable controller and an application specific integrated circuit (ASIC), which is not limited herein. In the embodiment, the processing unit 16 accesses and executes the modules stored in the storage unit 14 to achieve the touch screen operating method.

In detail, FIG. 2 is a flow chart showing a touch screen operating method in an embodiment. Please refer to FIG. 1 and FIG. 2, the method is applied to the electronic device 10. The steps in the method are illustrated with the components of the electronic device 10 in FIG. 1 as follows.

First, at least a portion of the data items of the data page are displayed at the touch screen 12 by the display module 142 (step S202). The data page may be a page of an address book, a calendar, a memorandum, an application or a file (which includes a music file, an image file, a video file and a document file), which is not limited herein. When the number of the data items of the data page is too large, and the displaying area of the touch screen 12 cannot display all of the data items, the display module 142 only displays a portion of the data items according to a listing order, and the user can slide the data page to check the other data items.

In detail, the detecting module 144 detects the touch operation gesture to the displayed data items via the touch screen 12 (step S204). The detecting module 144 may detect a dragging operation on the data items and detect a sliding direction generated by the dragging operation, or the detecting module 144 detects a tapping operation on the data items and determines to slide upwards or downwards to generate a sliding direction according to a tapping position and tapping times.

The sliding module 146 slides the data items according to the touch operation gesture detected by the detecting module 144 (step S206). The sliding speed of the data items relates to a sliding speed and a sliding distance of the touch operation gesture. For example, the sliding speed of the data items is proportional to a sliding distance of the touch operation gesture, which is not limited herein.

In sliding of the data items, the sliding module 146 determines whether the data items are slide to the edge of the data page (step S208). The sliding module 146 may determine whether the last data item at the sliding direction is at the edge of the data page, and further determines whether the data items are already slid to the edge of the data page. For example, when the user slides downwards on the touch screen, the sliding module 146 slides the data items downwards, and whether the data item at the bottom of the touch screen 12 is the last data item of the data page is further determined at the same time, so as to determine whether the data items are already slid to the edge of the data page.

When the sliding module 146 determines the data items are not slid to the edge yet, the step S206 is executed, and the data items continue sliding according to the touch operation gesture. However, when the sliding module 146 determines the data items are already slid to the edge, the stacking module 148 stacks the data items slid by the sliding module 146 (step S210). The stacking module 148 may stack all of the data items between the data item touched by the touch operation gesture and the data item of the edge, and a portion of the data items are overlapped. For example, the previous data item overlaps a part of the next data item. The stacking module 148 may also determines the overlap configuration according to the touch operation gesture.

In an embodiment, the stacking module 148 determines an order of the data items alone the sliding direction of the touch operation gesture, and makes the previous data item overlap an upper part or a bottom part of the next data item. For example, when the user slides the data items downwards, the stacking module 148 determines the order of the data items is from top to down, and then it makes the previous data item (the upper one) overlap the upper part of the next data item (the bottom one) accordingly. On the contrary, when the user slides the data items upwards, the stacking module 148 determines the order of the data items is from bottom to top, and then it makes the previous data item (the bottom one) overlap the bottom part of the next data item (the upper one) accordingly.

When the stacking module 148 stacks the data items, it may determine an overlap ratio of the data items, such as a percentage of the covered part which is covered by the previous data item on the next data item, according to a sliding distance or a sliding speed of the touch operation gesture. In an embodiment, when the sliding distance of the touch operation gesture is longer, or the sliding speed is higher, the overlap ratio of the previous data item overlapping the next data item by the stacking module 148 is larger. In the embodiment, in order to check the contents of the overlapped data items, the overlap ratio of the previous data item overlapping the next data item may be set to 50% at the most. That means, when half of the data item is covered, this data item would not be further covered. In another embodiment, the overlap ratio is not limited. That means, the data item touched by the finger stacks and overlaps all the other data items at the sliding direction.

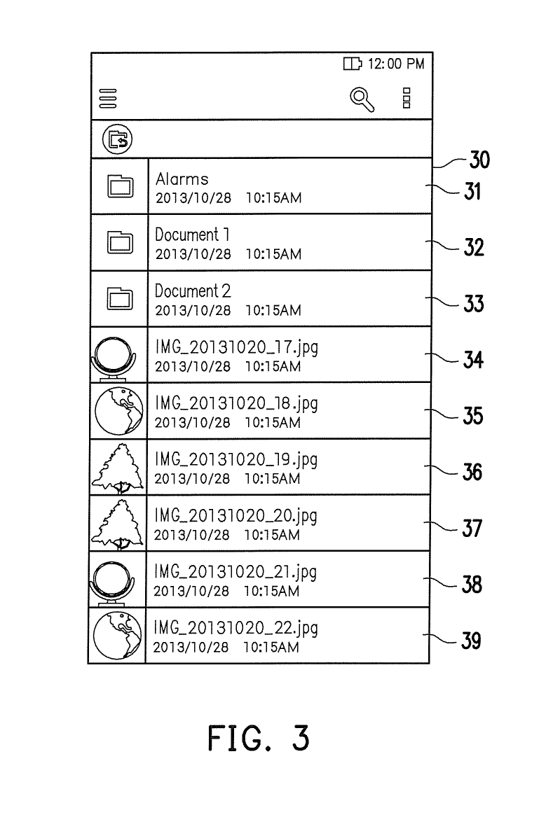

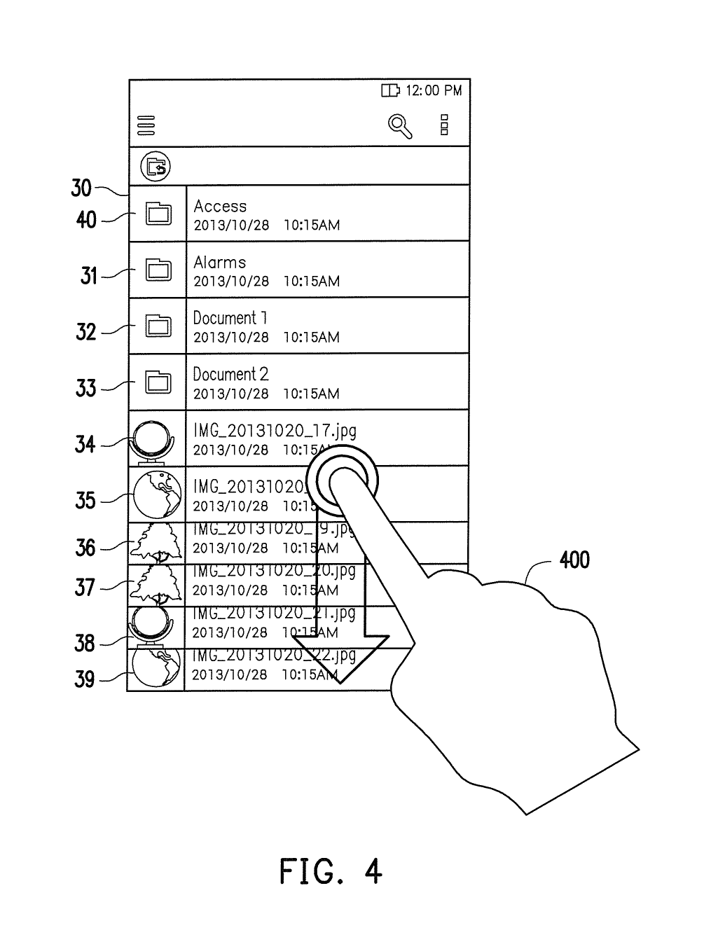

For example, FIG. 3 is a schematic diagram showing a data page in an embodiment. FIG. 4 is a schematic diagram showing a touch screen operating method in an embodiment. Please refer to FIG. 3, the data page 30 in the embodiment is a file page and includes the data items 31 to 39. The data items 31 to 33 are folders, the data items 34 to 39 are pictures, and each of the data items displays a preview, a name and a date, which is not limited herein.

Please refer to FIG. 3 and FIG. 4, when the finger 400 touches the data item 35 of the data page 30 and slides the data item 35 downwards, the whole data page 30 is slid downwards. It assumes that the data item 39 is at the edge of the data page 30, and when the data page 30 is slid downwards, the data items 35 to 39 between the data item 35 touched by the finger 400 and the data item 39 at the edge of the data page 30 are stacked. Alone the sliding direction of the touch operation gesture, the data items 35 to 39 are stacked in a configuration that the previous data item (the upper one) overlaps the upper part of the next data item (the bottom one). For example, the data item 35 covers the upper part of the data item 36, and the overlap ratio is based on the sliding distance of the touch operation gesture. When the data page 30 is slid downwards, the data item 40 above the data item 31 appears in the upper part of the data page 30, and as the sliding distance becomes longer, more data items appears above the data item 31. Thus, the user can check the data items above the data item 31 via the touch operation gesture.

When the stacking module 148 stacks the data items, the sliding module 146 determines whether the touch operation gesture is dismissed (which means whether the user finger leaves the touch screen 12), and replaces the data items stacked by the stacking module 148 with the unstacked state when it is determined that the touch operation gesture is dismissed.

As stated above, users would know that the touch operation gesture is touching the edge of the data page according to the stacked data items that demonstrated on the display. Consequently, the method and the electronic device can provide a better operating experience.

when the sliding module 146 slides the data items, besides that it determines whether the last data item at the sliding direction is at the edge of the data page and stacking the data items accordingly, the sliding module 146 also determines whether the last data item at the direction opposite to the sliding direction is at the opposite edge of the data page. If the last data item is at the opposite edge of the data page, the sliding module 146 slides the data items alone the sliding direction of the touch operation gesture, and displays a blank space between the last data item and the other edge of the data page, so as to remind the user that the data items at the direction opposite to the sliding direction are also slid to the edge of the data page.

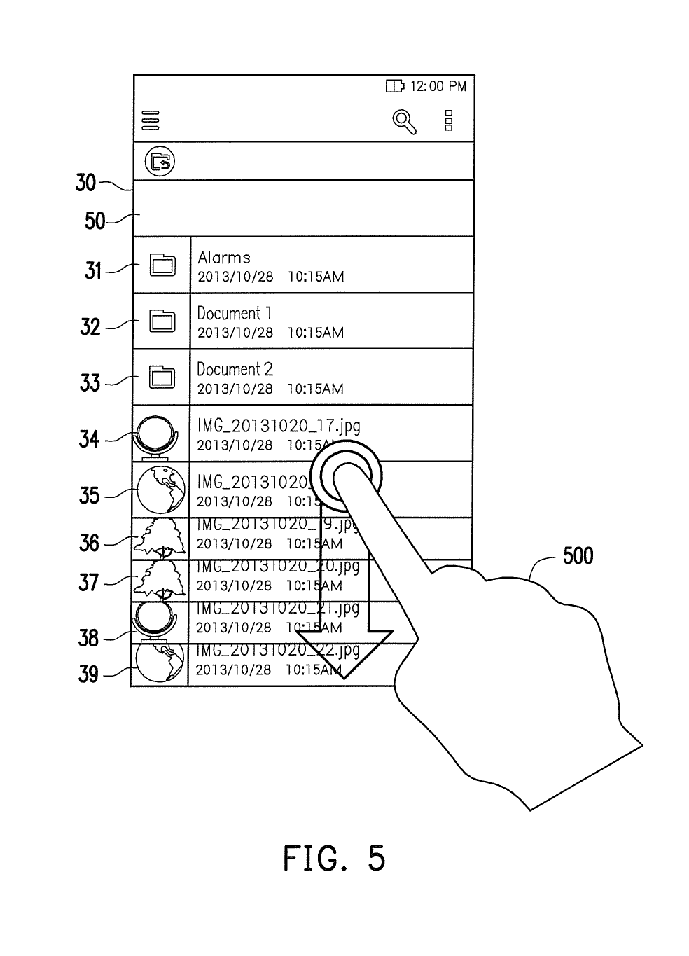

For example, FIG. 5 to FIG. 7 are schematic diagrams showing the touch screen operating method in embodiments, respectively. The data page 30 in FIG. 3 is taken as an example to illustrate the touch screen operating method.

Please refer to FIG. 3 and FIG. 5, when the finger 500 touches the data item 35 of the data page 30 and slides the data item downwards, the whole data page 30 is slid downwards. It is assumed that the data item 39 is at the bottom edge of the data page 30, and when the data page 30 is slid downwards, the data items 35 to 39 are stacked. The stacking manner is similar to that in the embodiment in FIG. 4, which is omitted herein for a concise purpose. The difference between the embodiment and the previous embodiment is that the data item 31 is at the upper edge of the data page 30, thus, when the data page 30 is slid downwards, a blank space 50 is displayed between the data item 31 and the upper edge of the data page 30, so as to remind the user that the data item (data item 31) at the direction opposite to the sliding direction is the final data item.

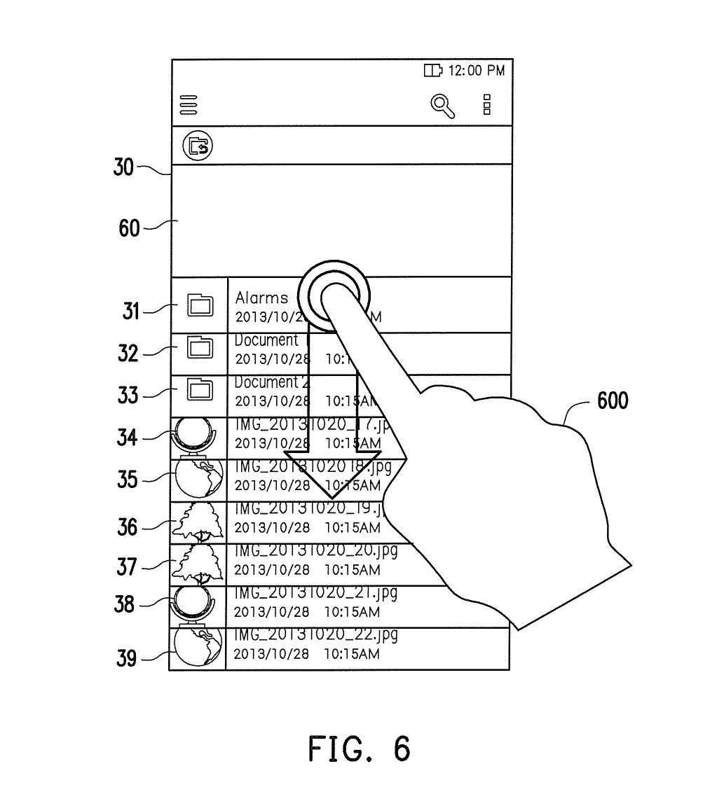

Please refer to FIG. 3 and FIG. 6, when the finger 600 touches the data item 31 of the data page 30 and slides it downwards, the whole data item of the data page 30 are slid downwards. It is assumed that the data item 39 is at the edge of the data page 30, and when the data page 30 is slid downwards, the data items 31 to 39 are stacked. The stacking manner is similar to that in the embodiment in FIG. 4, which is omitted herein for a concise purpose. The difference between the embodiment and the previous embodiment is that the data item 31 touched by the finger is at the upper edge of the data page 30, thus, when the data page 30 is slid downwards, all of the data items 31 to 39 are stacked, so as to remind the user that the data items at the sliding direction are slid to the edge of the data page. Moreover, a blank space 60 is displayed between the data item 31 and the upper edge of the data page 30, so as to remind the user that the data item (data item 31) at the direction opposite to the sliding direction is the final data item.

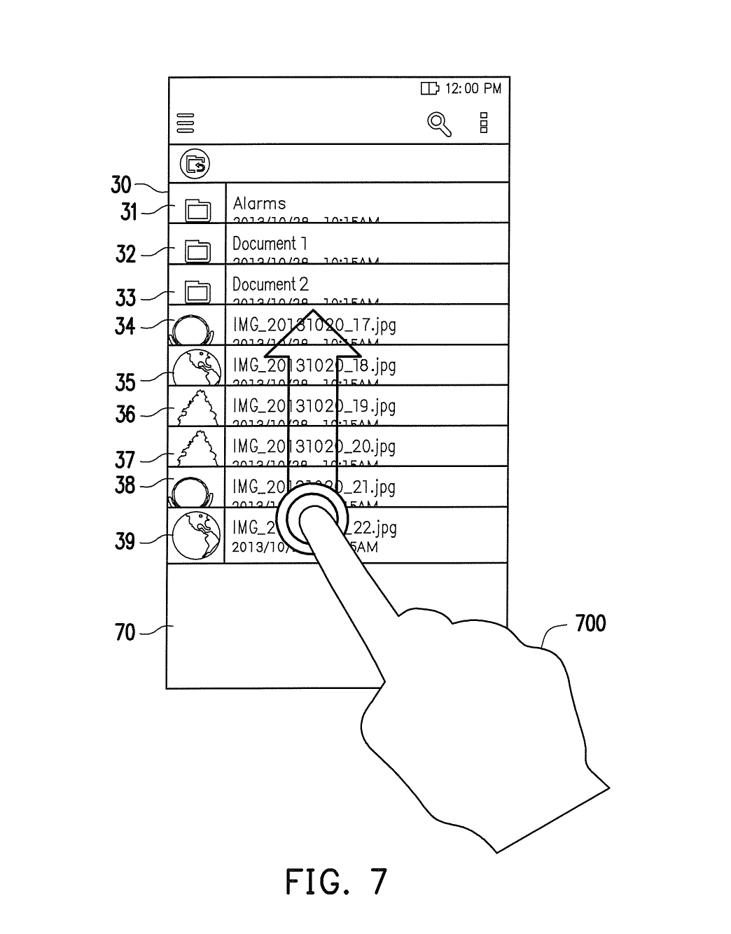

Please refer to FIG. 3 and FIG. 7, when the finger 700 touches the data item 39 of the data page 30 and slides upwards, the whole data items of the data page 30 are slid upwards. It is assumed that the data item 31 is at the upper edge of the data page 30, and when the data page 30 is slid upwards, the data items 31 to 39 are stacked. The difference between the embodiment and the previous embodiment is that the sliding direction in this embodiment is from bottom to top, and thus the data items 31 to 39 are stacked in a configuration that the previous data item (the bottom one) overlaps the bottom part of the next data item (the upper one). For example, the data item 39 covers the bottom part of the data item 38, and the overlap ratio is based on the sliding distance of the touch operation gesture. Moreover, since the data item 39 touched by the user is also at the bottom edge of the data page 30, when the data page 30 is slid upwards, all of the data items 31 to 39 are stacked. Additionally, a blank space 70 is displayed between the data item 39 and the bottom edge of the data page 30, so as to remind the user that the data item (data item 39) at the direction opposite to the sliding direction is the final data item.

In the embodiments, the stacking of the data items is executed when the touch operation gesture continues. However, in another embodiment, the stacking of the data items is executed based on the inertia of the sliding. In detail, when the user finger slides at the touch screen rapidly, the data items are also slid rapidly. Even though the finger already leaves the touch screen, the data items keeps moving, and the moving speed decreases gradually until the data items stop. Before the moving stops, if the data items are slid to the edge of the data page, the slid data items are stacked to remind the user that the sliding already reaches the edge of the data page. At the moment, the overlap ratio of the data items is based on the moving speed of the data items.

In sum, in the touch screen operating method and the electronic device, the data items of the data page are slid according to the touch operation gesture from the user, and when the data items are slid to the edge of the data page, they are stacked alone to at least one of the sliding direction and the sliding distance, the sliding direction and the sliding speed of the touch operation gesture. When the sliding distance is longer or the sliding speed is higher, the overlap ratio of the data items is larger. Consequently, the user can know that the sliding reaches the edge and stops the sliding operation.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A touch screen operating method, applied to an electronic device, comprising following steps:
detecting a touch operation gesture at the touch screen, wherein the touch screen displays at least a portion of a plurality of data items of a data page;
sliding the data items according to the touch operation gesture; and
stacking the slid data items when the data items are slid to an edge of the data page.

2. The touch screen operating method according to claim 1, wherein the step of sliding the data items according to the touch operation gesture further comprises:
determining whether a last data item at the sliding direction is at the edge of the data page.

3. The touch screen operating method according to claim 1, wherein the step of stacking the slid data items when the data items are slid to the edge further comprises:
overlapping a portion of the data items.

4. The touch screen operating method according to claim 1, wherein after the step of stacking the slid data items when the data items are slid to the edge, the method further comprises:
displaying a blank space at the data page.

5. The touch screen operating method according to claim 3, wherein the step of overlapping a portion of the data items further comprises:
determining an overlap ratio of the data items according to a sliding distance or a sliding speed of the touch operation gesture.

6. The touch screen operating method according to claim 1, wherein the step of stacking the slid data items further comprises:
stacking the data items between the data item touched by the touch operation gesture and the data item at the edge.

7. The touch screen operating method according to claim 1, wherein after the step of stacking the slid data items, the method further comprises:
determining whether the touch operation gesture is dismissed; and
restoring the stacked data items to an unstacked state when the touch operation gesture is dismissed.

8. An electronic device, comprising:
a touch screen;
a storage unit including a plurality of modules; and
a processing unit coupled to the touch screen and the storage unit to access and execute the modules stored in the storage unit, wherein the modules includes:
a display module displaying at least a portion of a plurality of data items of a data page at the touch screen;
a detecting module detecting a touch operation gesture on the displayed data items via the touch screen;
a sliding module sliding the data items according to the touch operation gesture; and
a stacking module stacking the data items when the sliding module determines whether the touch operation gesture touched an edge of the data page.

9. The electronic device according to claim 8, wherein the sliding module determines whether the last data item at the sliding direction is at the edge of the data page.

10. The electronic device according to claim 8, wherein the stacking module makes a portion of the data items overlapped.

11. The electronic device according to claim 10, wherein the stacking module determines a sliding distance or a sliding speed of the touch operation gesture and determines an overlap ratio of the data items.

12. The electronic device according to claim 8, wherein the stacking module stacks the data items between the data item touched by the touch operation gesture and the data item at the edge.

13. The electronic device according to claim 8, wherein the sliding module further determines whether the touch operation gesture is dismissed, and replaces the data items stacked by the stacking module with an unstacked state when the touch operation gesture is dismissed.
